(19) United States
(12) Patent Application Publication
(10) Pub. No.: US 2003/0211205 A1
(43) Pub. Date: Nov. 13, 2003

(54) Spaghetti Twister and method for making same

(76) Inventor: Sylvester Madison, Dillon, SC (US)

Correspondence Address: SARA A. CENTIONI, NEXSEN PRUET JACOBS & POLLARD, LLC, PO DRAWER 2426, COLUMBIA, SC, 29202-2426, US

(21) Appl. No.: 10/144,463

(22) Filed: May 13, 2002

(51) Int. Cl. A23G 1/00

(52) U.S. Cl. 426/104

(57) ABSTRACT

An edible utensil for winding up elongated pasta having projections extending radially from the surface of the utensil. The utensil is made of a food product such as bread that is reasonably rigid to hold bundles of elongated pasta. In operation, the utensil is placed against a plate containing a type of elongated pasta while the utensil is grasped. The utensil is substantially vertically positioned with respect to the plate. The user then rotates the utensil so that the strands of pasta wind up onto the tines of the utensil. The pasta and the portion of the utensil surrounded by the pasta are then consumed in the ordinary manner.

### 1. FIELD OF THE INVENTION

The present invention relates generally to utensils used for eating spaghetti, and, in particular, to an edible utensil for twisting up and eating spaghetti.

### 2. BACKGROUND OF THE INVENTION

Edible analogs of eating utensils are known. These types of utensils are both useful and enjoyable because they often allow the user to eat a number of ingredients simultaneously that usually would be eaten separately, and they also decrease the amount of clean up time after a meal because they are consumed and need not be washed.

However, there has yet to be made an edible utensil for eating elongated pasta. One of the most popular and enjoyable meals known includes spaghetti that is served with a type of sauce such as marinara or alfredo. As a complement to this meal, bread is included, which is typically used to sop up any excess or residual sauce. Often, the bread is served in slices that have been cut from a long loaf of Italian or French bread.

Notwithstanding the obvious popularity of this meal, the eating process involved with the spaghetti meals can be somewhat arduous. Even the most careful diner sometimes splatters sauce during the eating process. The spaghetti must first be rotated or twisted into a bundle by a person using a utensil having tines such as a fork. The utensil is then raised to bring the bundle of spaghetti into the person's mouth for eating. During this process, the pasta strands tend to slip of the utensil if the bundle that is formed is not compact. Further, the rotary motion of the utensil during the twisting or winding of the pasta can cause the sauce clinging to the strands to be thrown off onto the diner's clothes or the surrounding tablecloth.

These problems are reduced with the addition of bread to the meal. With a utensil in one hand and the bread in the other, the diner may place the bread below the utensil and then begin twirling the pasta strands. Alternatively, a spoon may be used in combination with a utensil such as a fork. First, the spoon is placed in the pasta, and then tines of the fork are placed into the spoon bowl and turned so that the pasta strands are twisted onto the fork. Both of these methods result in a more compact bundle of pasta. However, a down side to these methods is that both of the diner's hands must be engaged. Further, the excess sauce still tends to splatter off of the strands of pasta.

Therefore, there remains a need for an edible utensil for winding and eating elongated pasta that results in the diner exerting less effort and having a more enjoyable eating experience.

### SUMMARY OF THE INVENTION

According to its major aspects and briefly stated, the present invention is an edible utensil for twisting up elongated pasta and a method for making the same. Utensil refers to a device for facilitating the movement of food to the mouth of the user. The utensil of the present invention is generally rod-like shaped and has projections extending from the utensil that are used for winding the elongated pasta. The utensil is made of a food product, such as bread, that is reasonably rigid and adapted to be made into one of the following requisite forms.

In one embodiment, the utensil has an upper handle portion and a lower winding portion portion. The winding portion of the utensil includes multiple tines that extend radially from the utensil along its longitudinal length.

In use, the lower winding portion of the utensil is placed against a plate containing a type of elongated pasta while the handle portion of the utensil is grasped. The utensil is substantially vertically positioned with respect to the plate. The user then rotates the utensil so that the strands of pasta wind up onto the tines of the utensil. The pasta and the portion of the utensil surrounded by the pasta are then consumed in the ordinary manner.

In another alternative embodiment, the utensil has an upper handle portion and a lower winding portion. The winding portion of the utensil includes a helical groove along the longitudinal length of the utensil. Similar to the previously described embodiment, in use, the lower winding portion of the utensil is placed against a plate containing a type of elongated pasta while the handle portion of the utensil is grasped. The utensil is substantially vertically positioned with respect to the plate. The user then rotates the utensil so that the strands of pasta wind up onto the grooves of the utensil. The pasta and the portion of the utensil surrounded by the pasta are then consumed in the ordinary manner.

In yet another alternative embodiment, the utensil generally has an upper handle portion and a lower winding portion. The winding portion of the utensil includes multiple hooks that extend radially from the utensil along its longitudinal length. The utensil is used much the same way as the previously described embodiments in that the user rotates the utensil so that the strands of pasta wind up onto the hooks of the utensil.

The present invention further includes a method for making an edible utensil for winding up elongated pasta. The method includes the following steps: 1) providing a mold having a base member and a cover member that form a cavity that is rod-like shaped with indentations or grooves; 2) filling the base member of the mold with a mass of dough; 3) closing the mold; 4) cooking the dough mass so that the dough rises and fills the cavity of the mold; 5) removing the cooked dough mass from the mold; and 6) cooling the cooked dough mass. Once the edible utensil has been sufficiently cooled, a user may introduce it into a plate filled with elongated pasta and begin eating the meal.

A feature of the present invention includes the use of an edible utensil, and, in particular the use of an edible utensil made of a food product, such as bread, for twisting up and eating elongated pasta. It is known to include bread or bread-like products with spaghetti meals. This bread is typically used to soak up excess or residual sauce, as well as shorter strands of pasta. This process is often messy and can result in the splattering of sauce. Further, the winding of elongated pasta onto utensils such as forks may be troublesome with the use of an additional utensil such as a spoon. The present invention allows the user of the utensil to accomplish both the winding of the pasta strands and the soaking up of the residual sauce simultaneously with one utensil. In addition, the diner's overall eating experienced is enhanced because the utensil itself can be consumed. Further, the sauce splattering resulting from the twisting of the pasta is reduced, which helps to keep the user's clothes and the surrounding area clean, as well as to alleviate any embarrassment or discomfort a user may feel about the splattering. Finally, the clean up time involved is reduced as the utensil is consumed during the meal and need not be washed.

Yet another feature of the present invention is the use of the projections extending from utensil in the form of multiple tines, a helical groove, and multiple hooks. Typically, the tines of forks or other utensils used for twisting up pasta strands lie in the same flat or curved plane, and are parallel to the longitudinal axis of the handle of the fork. Accordingly, the pasta strands tend to slip off the tines when the fork is substantially vertically position because of gravitational forces. In the present invention, the tines extend out radially from the base of the utensil and are substantially perpendicular to the longitudinal axis of the utensil. Therefore, the strands of pasta are actually supported by the tines and will not slip off the utensil. Further, the tines are staggered and unaligned, which enables the user to increase the amount of pasta strands that are wound onto the utensil and to more efficiently form a bundle at the end of the utensil. Finally, the tines extend up the longitudinal length of the utensil so that if some of the tines are consumed after the first bundles of pasta are formed, there will still be additional tines further up the longitudinal length of the utensil for winding up the remaining pasta.

The groove of the utensil also facilitates the winding of the pasta strands. Further, the groove supports the pasta strands once they have been wound and prevents the strands from slipping off the utensil. Additionally, the helical groove extends up the length of the utensil so that when part of the groove is consumed during the eating process, there still will be additional groove for winding up pasta.

Similarly, the multiple hooks help to anchor the strands of pasta and prevent the pasta from sliding back onto the plate once it has been wound. Further, because the hooks extend up the length of the utensil, the pasta can continue to be wound even after part of the hooks have been consumed.

Other features and their advantages will be apparent to those skilled in the art of utensils for winding up elongated pasta from a careful reading of the Detailed Description of Preferred Embodiments accompanied by the following drawings.

### BRIEF DESCRIPTION OF THE DRAWINGS

In the drawings,

FIG. 1 is a side view of an edible utensil for winding elongated pasta according to a preferred embodiment of the present invention;

FIG. 2 is a perspective view of an edible utensil for winding elongated pasta in use according to a preferred embodiment of the present invention;

FIG. 3 is a side view of an edible utensil for winding elongated pasta according to an alternative preferred embodiment of the present invention;

FIG. 4 is a side view of an edible utensil for winding elongated pasta according to an alternative preferred embodiment of the present invention; and

FIG. 5 is a perspective view of a mold used for making an edible utensil for winding elongated pasta according to a preferred embodiment of the present invention.

### DETAILED DESCRIPTION OF PREFERRED EMBODIMENTS

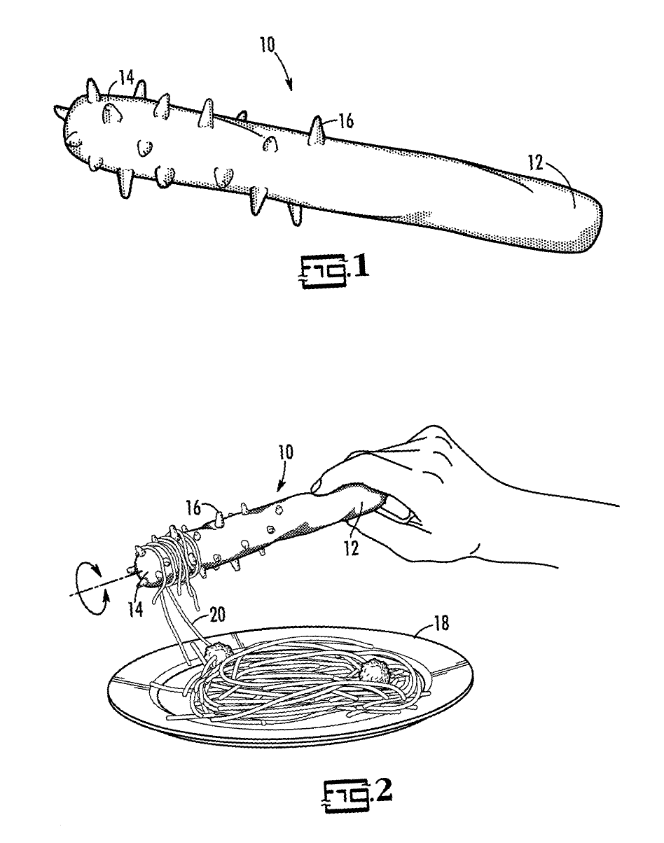

Referring now to the drawings, and in particular to FIG. 1, the numeral 10 generally designates an edible utensil for winding elongated pasta made in accordance with the invention. As shown, utensil 10 has a rod-like shape and includes an upper handle portion 12 and a lower winding portion 14 that includes multiple tines 16. Multiple tines 16 extend radially from utensil 10 along the longitudinal length of utensil 10 and are substantially perpendicular to the longitudinal axis of utensil 10. Alternatively, utensil 10 may be made without upper handle portion 12 and include only winding portion 14 having multiple tines 16 throughout its entire longitudinal length. Preferably, edible utensil 10 is made of a type of food product, such as bread. The food product should be reasonably rigid and adapted to be made in the described form. For the purposes of this detailed description and the appended claims, “reasonably rigid” refers to the required stiffness or rigidity of the food product making it capable of withstanding the weight of a bundle of elongated pasta without bending or breaking. A desirable feature of the baked would be that it is capable of absorbing sauce.

FIG. 2 illustrates utensil 10 in use. As shown, lower winding portion 14 of utensil 10 is placed against a plate 18 containing a type of elongated pasta 20 while handle portion 12 of utensil 10 is grasped. Any type of elongated pasta 20 can be used in connection with utensil 10, including spaghetti, capelli d'angelo, fettuccine, linguini, and vermicelli. Utensil 10 is substantially vertically positioned with respect to plate 18. The user then rotates utensil 10 so that the strands of pasta 20 wind up onto multiple tines 16 near the bottom of utensil 10. Elongated pasta 20 can then be removed from utensil 10 in the ordinary manner. Furthermore, the portion of utensil 10 surrounded by pasta 20 can also be consumed by the user, which enhances the overall dining experience.

As previously discussed a particular feature of the present invention is the use of edible utensil 10, and, in particular, the use of an edible utensil 10 made of a food product for winding and eating elongated pasta 20. Not only does utensil 10 complement increase the enjoyment of the meal for the diner by harmonizing various ingredients or food products that are typically be eaten separately, but utensil 10 will also soak up residual and excess sauce that is carried by the strands of pasta 20 thereby reducing the potential splattering of sauce during the rotating of pasta strands onto utensil 10. Further, the user of utensil 10 can both wind elongated pasta 20 onto utensil 10 and soak up the excess or residual sauce simultaneously with one utensil, thereby reducing the hassle and potential mess associated with the use of one utensil in combination with a slice of bread or two utensils, such as a fork and a spoon. Finally, the clean up time involved is reduced as the utensil is consumed during the meal and need not be washed.

Another feature of the present invention is the use of multiple tines 16. The orientation of multiple tines 16 is such that bundles of elongated pasta 20 can be formed efficiently and without the use of an additional utensil. Further, multiple tines 16 are included along the longitudinal length of utensil 10. Therefore, additional tines remain for winding elongated pasta 20 in the case that some of multiple tines 16 are consumed during the eating process. This feature reduces the need to use new edible utensils 10 each time a bundle of pasta is formed and thereafter consumed.

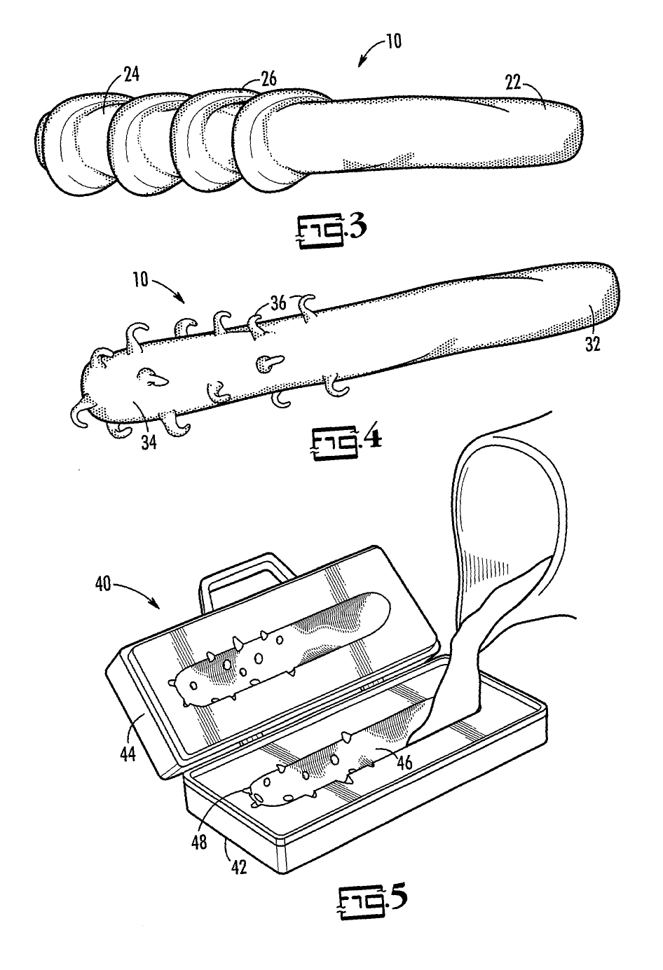

An alternative embodiment of edible utensil 10 is shown in FIG. 3. Utensil 10 has a rod-like shape and includes an upper handle portion 22 and a lower winding portion 24 that includes a helical groove 26. Alternatively, utensil 10 may be made without upper handle portion 22 and include only winding portion 24 having helical groove 26 throughout its entire longitudinal length. Preferably, edible utensil 10 is made of a type of food product, such as bread. The food product should be reasonably rigid and adapted to be made in the described form. A desirable feature of the food product would be that it is capable of absorbing sauce.

Utensil 10 is used much the same way as the previously described embodiment and involves placing winding portion 24 of utensil against a plate containing elongated pasta while grasping handle portion 22. The user then winds the strands of pasta onto helical groove 26 of utensil 10.

The use of helical groove 26 is also a particular feature of the present invention. The shape and orientation of groove 26 facilitates the winding of the pasta strands. Further, helical groove 26 supports the pasta strands once they have been wound and prevents the strands from slipping off utensil 10. Additionally, helical groove 26 extends up the longitudinal length of utensil 10 so that when part of groove 26 is consumed early on during the meal, the rest of helical groove 26 will remain for winding up pasta.

Yet another alternative embodiment of edible utensil 10 is illustrated in FIG. 4. Utensil 10 is rod-like shaped and includes an upper handle portion 32 and a lower winding portion 34 that includes multiple hooks 36. Alternatively, utensil 10 may be made without upper handle portion 32 and include only winding portion 34 having multiple hooks 36 throughout its entire longitudinal length. Preferably, edible utensil 10 is made of a type of food product, such as bread. The food product should be reasonably rigid and adapted to be made in the described form. A desirable feature of the baked would be that it is capable of absorbing sauce. As with the previously described embodiments, utensil 10 is used by placing winding portion against a plate containing elongated pasta while grasping handle portion 32. The user then winds the strands of pasta onto multiple hooks 36 of utensil 10.

The use of multiple hooks 36 is another feature of the present invention. Multiple hooks 36 help to anchor the strands of pasta to utensil 10 and prevent the pasta from sliding back onto the plate once it has been wound. Further, because multiple hooks 36 extend up the longitudinal length of utensil 10, the pasta can continue to be wound even after part of multiple hooks 36 have been consumed.

The present invention further includes a method for making edible utensil 10. As illustrated in FIG. 5, the first step includes providing a mold 40 having a base member 42 and a cover member 44 that form a cavity 46 that is rod-like shaped. Depending on the shape desired for the winding portion of utensil 10, base member 42 and cover member 44 of mold 40 include indentations 48 (showing in FIG. 5) or grooves. Although mold 40 shown in FIG. 5 includes one cavity 46 for forming one utensil 10 simultaneously, the use of an increased number of cavities 46 is contemplated by the present invention.

Once the appropriate mold 40 is selected, base member 42 of the mold 40 is filled with a mass of dough. The dough includes batter and is made of flour, liquid, and leavening. The flour can be made from wheat, rice, and other grains. The leavening includes yeast, baking soda, baking powder, and mixtures thereof. Next, mold 40 is closed and placed in a heating apparatus such as an oven for baking. Alternatively, a means for heating in the form a heating resistance type element or coil can be placed within base member 42 and/or cover member 44 so that utensil may be cooked directly inside mold 40.

Once dough has been sufficiently cooked, the cook dough, which now forms the finished utensil 10, is removed from mold 40 and allowed to cool. After a sufficient amount of cooling, a user may introduce utensil 10 into a plate filled with elongated pasta and begin eating the meal.

It will be apparent to those skilled in the art that many changes and substitutions can be made to the preferred embodiments and method herein described without departing from the spirit and scope of the present invention as defined by the appended claims.

What is claimed is:

1. A device for use in winding elongated pasta, comprising:
a food product having projections, a handle portion, and a winding portion, said projections being carried on said winding portion.

2. The device as recited in claim 1, wherein said food product is baked.

3. The device as recited in claim 1, wherein said food product has projections selected from a group consisting of multiple tines, a helical groove, and multiple hooks.

4. The device as recited in claim 1, wherein said food product is bread.

5. The device as recited in claim 1, wherein said food product is reasonably rigid.

6. The device as recited in claim 1, wherein said food product is rod-like shaped having a longitudinal axis.

7. The device as recited in claim 6, wherein said projections extend radially from said food product and are substantially perpendicular to said longitudinal axis.

8. A device for use in winding elongated pasta, comprising:
a food product carrying projections.

9. The device as recited in claim 8, wherein said food product is rod-like shaped having a longitudinal length.

10. The device as recited in claim 9, wherein said projections are carried along entire said longitudinal length.

11. The device as recited in claim 8, wherein said projections are selected from a group consisting of multiple tines, a helical groove, and multiple hooks.

12. The device as recited in claim 8, wherein said food product is rod-like shaped having a longitudinal axis.

13. The device as recited in claim 12, wherein said projections extend radially from said food product and are substantially perpendicular to said longitudinal axis.

14. The device as recited in claim 8, wherein said food product is reasonably rigid.

15. The device as recited in claim 8, wherein said food product is bread.

16. A method for making a utensil, said method comprising the following steps:
forming a mold of a utensil having projections extending therefrom;
making dough;
using said mold to form said dough; and
baking said formed dough.

17. The method as recited in claim 16, wherein said projections are selected from the group consisting of multiple tines, a helical groove, and multiple hooks.

18. The method as recited in claim 16, wherein said formed dough is baked in said mold.

19. The method as recited in claim 17, wherein said mold is formed to make a utensil having a handle portion and an opposing winding portion.

20. The method as recited in claim 19, wherein said projections are carried by said winding portion.
